(19) United States
(12) Patent Application Publication
(10) Pub. No.: US 2012/0324244 A1
(43) Pub. Date: Dec. 20, 2012

(54) KIOSK DISTRIBUTION OF LICENSED CONTENT TO PORTABLE DEVICE WITHIN DVD AVAILABILITY WINDOW

(76) Inventors: Joseph Zipperer, Seattle, WA (US); Greg Martin, Des Moines, WA (US); Eric Letsche, Snoqualmie, WA (US); Aaron Birrell, Seattle, WA (US); James Zipperer, Seattle, WA (US)

(21) Appl. No.: 13/445,503

(22) Filed: Apr. 12, 2012

Related U.S. Application Data
(60) Provisional application No. 61/474,671, filed on Apr. 12, 2011.

(51) Int. Cl. G06F 12/14

(52) U.S. Cl. 713/193

(57) ABSTRACT

A system and method are disclosed for kiosk distribution of licensed content to one or more portable devices. The system stores and distributes licensed content in such a manner as to be compatible with the DVD window such that MFN contract provisions are not triggered during the window. Therefore consumers can use the system to purchase additional content or watch content that has been previously purchased without any blackout period as experienced using other content distribution methods such as Internet video streaming or other types of digital download services.

### CROSS-REFERENCE TO RELATED APPLICATIONS

This application claims the benefit of U.S. Provisional Application No. 61/474,671, filed Apr. 12, 2011, which is incorporated by reference in its entirety.

### TECHNICAL FIELD

The disclosure generally relates to the field of video playback devices, and more particularly, those devices that play content from a digital library stored either locally or in the cloud.

### BACKGROUND

Movie studios have introduced availability windows, or availability time periods, in order to maximize the revenue obtained for any particular movie. The current movie windows are theatrical, hospitality, DVD, Pay-TV (sometimes called the HBO window), and commercial broadcast. Theatrical is defined as when the movie is available within theaters. The next window, hospitality, is defined as when the movie is available in hotels and airplanes. Within these first windows, video product is available on a pay-per-view basis. The consumer does not own the content.

The DVD window is next and represents the first time period when a consumer can purchase content to own as well as rent the content. Only the DVD window represents a time when the customer can purchase content and typically overlaps the Video On Demand (VOD) window. The DVD window is also used by many Video On Demand services. VOD may be provided through such content delivery mechanisms as cable, satellite, and Internet streaming. Internet streaming services may also offer a digital locker service whereby a consumer may purchase content that is stored in a digital locker. The content can then be played over and over, without per-use viewing charges.

Pay-TV is considered a form of network delivery and therefore any other forms of network delivery are prohibited during the Pay-TV window. Such forms of network delivery include those in the aforementioned DVD window, namely VOD and Internet streaming. During the Pay-TV exclusivity period, consumers who had previously purchased content and stored that content within a digital locker service, such as those used by Internet streaming, are also prohibited from accessing purchased content due to the exclusivity. Exclusivity is independent of rental or purchase, so content within digital lockers cannot be viewed during the Pay-TV window, even if the content was purchased prior to the window. This is because both the content and the content keys are delivered over a network: the Internet.

Physical goods, such as DVDs and content preloaded on flash devices or mediums, are available for sale at any time during the Pay-TV. Physical goods are exempt from the restrictions because content and keys reside on the same physical medium and no network is required for key or content delivery. Therefore, physical goods have some characteristics that can never be matched by network or Internet streaming services or applications.

### Plug and Play Kiosk Architecture

FIG. 1 illustrates a “plug and play architecture for a kiosk digital content distribution system” of European Patent Application EP 2 113 880 A2. This patent application describes a method to distribute content where the main limitation is Internet bandwidth reducing the speed at which content can be downloaded to a device. While this disclosure addresses one fundamental issue with downloading large size files, several other practical limitations exist that are as fundamental as the download rate.

For example, Internet bandwidth can be increased for a cost. The cost then becomes the significant driver as the bandwidth is solvable in many locations by purchasing more bandwidth from the Internet service provider (ISP).

Storage is another important cost driver. Although significant advances have been made in video encoding technology, the advent of such technologies as high definition (e.g., Bluray, 720p, 1080p) and 3D have significantly increased the storage required for any one video file, not to mention multiple audio encodings which further increase the video file's size.

The kiosk of European Patent Application EP 2 113 880 A2 is described as a standalone system with all components within a single physical housing. In a multi-kiosk configuration, such as in a music store designed to allow multiple customers to interact at once, this configuration is overly expensive. Because all kiosks are self-contained, all content must be replicated to individual kiosks increasing the overall system cost for a retail location.

Another limitation of this physical design of the kiosk of European Patent Application EP 2 113 880 A2 is the physical size necessary to be allocated within the store itself. To retailers, floor space is a premium commodity and calculations such as inventory per square foot or revenue per square foot are industry recognized planning metrics. Therefore, physical kiosk size is also a barrier to adoption. Again thinking of multiple-kiosk configurations in any one store as a guide, minimizing the foot print in order to maximize the revenue per square foot is necessary.

Video content providers (such as movie and television studios) typically require digital rights management (DRM) in order to protect against content piracy. The choice of DRM and general paradigm (domain-based or device-based) is crucial. The license server is a traditional component necessary to implement DRM across the content distribution ecosystem. License servers are inherently expensive. They are expensive because managing DRM keys requires security elements in order to keep the keys properly protected. This technology is only made available from the entity that created the DRM. Since there is only one available supplier, cost is high. Deploying such servers therefore adds another incremental cost to every retail location.

In the system described in European Patent Application EP 2 113 880 A2, a domain based DRM is used. This type of DRM may be incompatible with the Pay-TV window when playing content. Within any domain based DRM, devices must first be registered to the domain before they can playback content. Registering devices necessitates that a single entity is used to distribute the keys necessary to playback content. A single entity naturally transferred keys over a network, and therefore subject to the same exclusivity within the Pay-TV window as other network-based implementations.

### BRIEF DESCRIPTION OF THE DRAWINGS

FIG. 1 illustrates a prior art kiosk digital content distribution system.

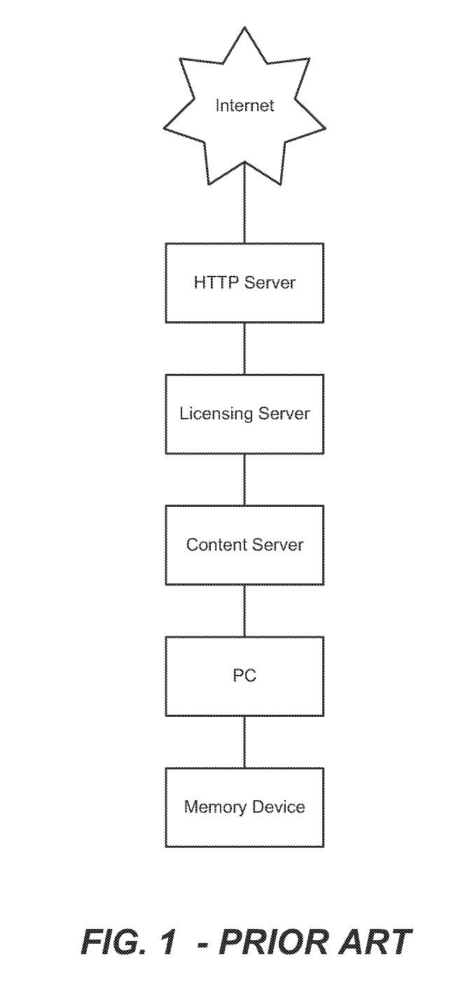

FIG. 2 illustrates one example embodiment of components of an example machine able to read instructions from a machine-readable medium and execute them in a processor (or controller).

FIG. 3 illustrates an example embodiment of a kiosk digital content distribution system.

FIG. 4 illustrates one embodiment of a multi-kiosk deployment in a single retail location.

FIG. 5 illustrates one example embodiment of a process for creating DRM keys in a distributed DRM-environment.

### DETAILED DESCRIPTION

The figures and the following description relate to example embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One will recognize from the following description that alternative embodiments of the structures, methods, and techniques, illustrated herein may be employed without departing from the principles described herein.

### Configuration Overview

According to an example embodiment, the system stores and distributes licensed content in such a manner as to be compatible with the DVD availability window such that it is also compatible with the restrictions imposed by the Pay-TV window. Therefore consumers can use the system to purchase additional content or watch content that has been previously purchased without any blackout period as experienced using other content distribution methods such as Internet video streaming or other types of digital download services that download the content and content keys via a network.

Example embodiments employ device-based DRM technology, which does not have the same limitation as domain-based DRMs with respect to the Pay-TV window. Device-based DRM's require secure storage and transfer to the device so that content can be played back on any compatible device that supports the DRM without registering that device. Using device-based DRMs device keys are not required to be centralized, as each compatible device contains a device key. Content Protection for Recordable media (CPRM) is an example of a device-based DRM.

One embodiment of a disclosed system, method and computer readable storage medium includes downloading digital media content from a kiosk to a secured digital (SD) card or other secured portable drive in such a manner as to be compatible with the DVD availability window (and not subject to the Pay-TV window) at the time that the digital media content is purchased or downloaded to a customer's SD card or other portable drive. In other words, the purchase can be made and the transaction completed from a kiosk with both the content and the content license available at the kiosk at the time of purchase. A download (or write) of digital content to the SD card comprises a manufacture or creation of an SD card with specified content. An SD card comprises a media device having computer readable and writable storage areas with a secure area and an unsecure area thereon. In one embodiment the storage area is comprised of a flash memory.

### Computing Machine Architecture

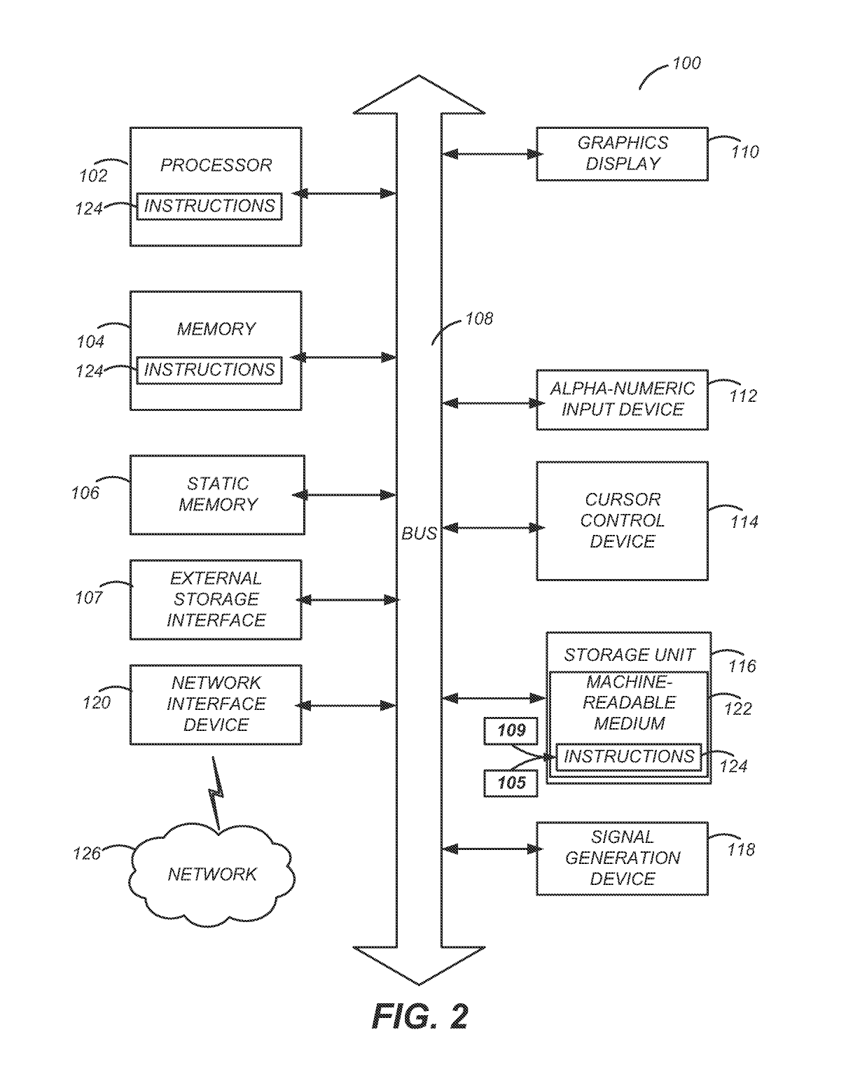

FIG. 2 is a block diagram illustrating components of an example machine able to read instructions from a machine-readable medium and execute them in a processor (or microcontroller). Specifically, FIG. 2 shows a diagrammatic representation of a machine in the example form of a computer system 100 within which instructions 124 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smart phone, a web appliance, a network router, switch or bridge, a gaming console, a Blu-ray Disc player, Television, or any machine capable of executing instructions 124 (sequential or otherwise) that specify actions to be taken by that machine. In addition, the machine may be configured to include instructions stored as firmware. Further, while only a single machine is illustrated, the term “machine” shall also be taken to include any collection of machines that individually or jointly execute instructions 124 to perform any one or more of the methodologies discussed herein.

The example computer system 100 includes a processor 102 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 104, and a static memory 106, which are configured to communicate with each other via a bus 108. The computer system 100 may further include graphics display unit 110 (e.g., a plasma display panel (PDP), a liquid crystal display (LCD), a projector, or a cathode ray tube (CRT)). The computer system 100 may also include alphanumeric input device 112 (e.g., a keyboard, remote control), a cursor control device 114 (e.g., a mouse, a trackball, a joystick, a motion sensor, or other pointing instrument), a persistent storage unit 116, a signal generation device 118 (e.g., a speaker), and a network interface device 120, which also are configured to communicate via the bus 108.

The storage unit 116 includes a machine-readable medium 122 on which is stored instructions 124 (e.g., software) embodying any one or more of the methodologies or functions described herein. The instructions 124 (e.g., software) may also reside, completely or at least partially, within the main memory 104 or within the processor 102 (e.g., within a processor's cache memory) during execution thereof by the computer system 100, the main memory 104 and the processor 102 also constituting machine-readable media. The instructions 124 (e.g., software) may be transmitted or received over a network 126 via the network interface device 120.

Also included in the computing system 100 is an external storage interface 107. The external storage interface in one embodiment may be a physical device that accepts SD card in various physical formats (SD card, mini SD, or micro SD) and interfaces the electrical characteristics such that the storage on the SD card can be accessed by the computing device. The external storage interface may also be used for adapters such as a USB-SD card reader, PC card-card reader, express card reader, USB flash drive or any other electrical interface such that the computing device can communicate with a storage device.

While machine-readable medium 122 is shown in an example embodiment to be a single medium, the term “machine-readable medium” should be taken to include a single medium or multiple media (e.g., a centralized or distributed database, or associated caches and servers) able to store instructions (e.g., instructions 124). The term “machine-readable medium” shall also be taken to include any medium that is capable of storing instructions (e.g., instructions 124) for execution by the machine and that cause the machine to perform any one or more of the methodologies disclosed herein. The term “machine-readable medium” includes, but not be limited to, data repositories in the form of solid-state memories, optical media, and magnetic media.

Machine-readable medium 122 also may include tangible, non-transitory storage mediums. The instructions stored thereon may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames).

In one example embodiment, the instructions 124 correspond to an application program 105. The application program 105 include a set of machine readable instructions to carry out key exchange and data transfer specifications as further described herein. In one example, the application program 105 may work with a digital rights management (DRM) key.

In addition, the example computer system 100 may include a SD secure application programming interface (API) 109. The SD Secure API is a software component that facilitates access to the SD card's secure area.

### Configuration of Kiosk Digital Content Distribution System

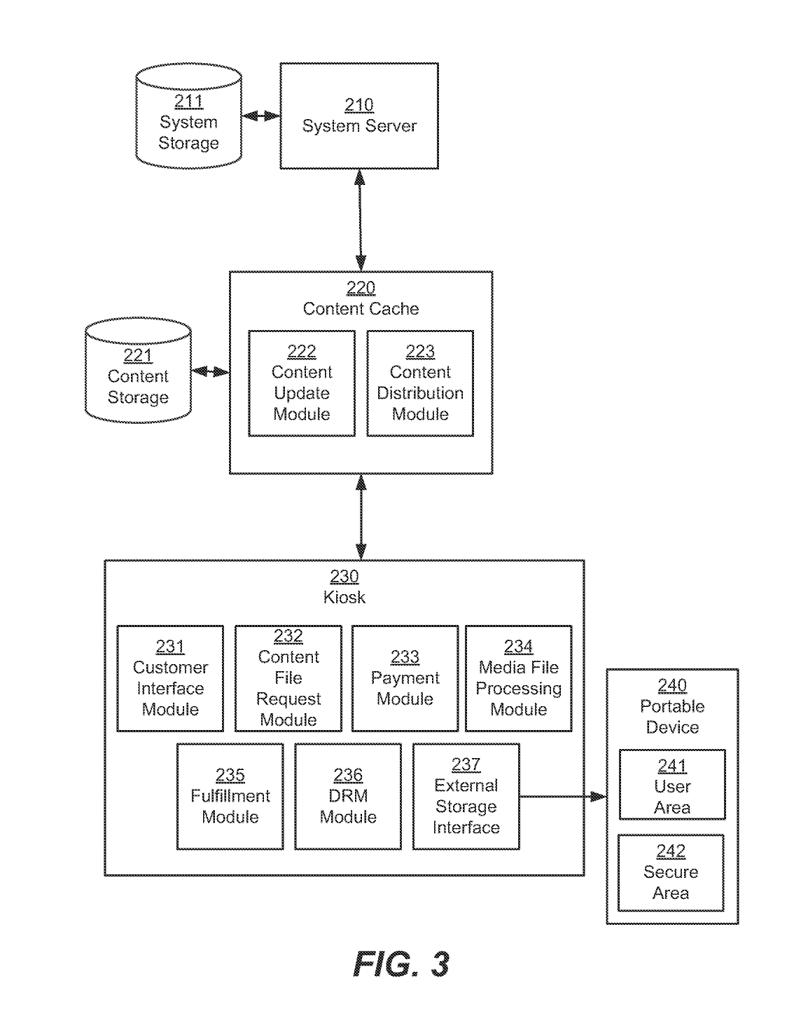

FIG. 3 illustrates an example embodiment of a kiosk digital content distribution system. The system storage 211 stores content files for distribution to stores through the system server 210. In one embodiment, the system storage 211 includes a database, system files, and user files stored on any combination of storage media. The content files stored in the system storage 211 can include audio, visual, and audio-visual files, for example, music, music videos, movies, television shows, video games, electronic books, etc. The content files may be stored at various quality standards and in various formats in order to accommodate various playback devices. The system server 210 accesses the content files stored in the system storage 211 and distributes them to at least one content cache 220 in response to a request for the content file from the content cache 220.

The kiosk 230 receives selections of content from customers, requests selected content files from the store server 220, and receives the content files in response to the requests, and writes the content files to the customer's portable device 240. In one embodiment, the kiosk 230 includes a customer interface module 231, a content request module 232, a payment module 233, a content file processing module 234, a fulfillment module 235, a DRM module 236, and an external storage interface 238.

The external storage interface 237 provides communicative connectivity between the portable device 240 and the kiosk 230. To that end, the external storage interface 237 may be a USB port, flash memory card slot (such as SD card), firewire, wifi, or other technology such that communication can be established between the kiosk 230 and the portable device 240. Portable devices may include, for example, mobile phones, table computers, portable computers, gaming devices, e-boot readers, portable media players, flash memory cards (SD card, compact flash), USB sticks (USB flash, USB hard disk drive), and/or portable hard drives (eSata, firewire) such that digital data can be transferred and stored on the portable device.

The customer interface module 231 manages a graphical user interface presented to a customer, through which, the customer can select content to preview at the kiosk 230 or download to the customer's portable device 240. The customer interface module 231 receives user selections of content for download, for example, by interpreting the user's interactions with a touch screen display of the kiosk 230 or though the user's alphanumeric input into a keyboard, button selections, or selections using a pointing device such as a computer mouse. The customer interface module 231 passes the user's selections to the content request module 232.

The content request module 232 prepares requests for content files. The content file request module 232 receives the user's selections of content from the customer interface module 231 and prepares a request for the corresponding content files, for example by performing a lookup of the selected content file.

The payment module 233 manages the payment details of the customer's purchase from the kiosk 230. The transaction module 233 receives the customer's payment information, for example from information read from the swipe of a card through a card reader (not shown) of the kiosk 230. Alternatively the payment module 233 can receive the customer's payment information as entered by the customer through alphanumeric or other input into the kiosk 230. The payment module 233 then processes the customer's payment according to the payment information received. The payment module 233 then verifies and confirms the customer's payment.

The fulfillment module 235 processes content files in preparation for writing the files to portable device 140. The fulfillment module 235 receives the requested content files from the store server 120. The fulfillment module 235 then queues the content file for download to the portable device 140. It is noted that the portable device can be provided by the customer (for insertion into the external storage interface 237 or otherwise communicatively coupled to the external storage interface, such as through a USB adaptor attached to a USB port of a kiosk 130) or may be provided through a kiosk that includes a pre-retained (e.g., stacked) quantity of devices inserted or coupled to the external storage interface 237 and subsequently discharged for the customer when the process described herein completes writing to the portable device.

The DRM module 236 performs DRM operations to the portable device 140. These operations may be distinct from the fulfillment module 235 in that if any DRM processing is specific to or specifically for a portable device or class of portable devices, this DRM module 236 will perform those actions. The DRM module 236 writes the protected files to the portable device 140 in compliance with the DRM specification.

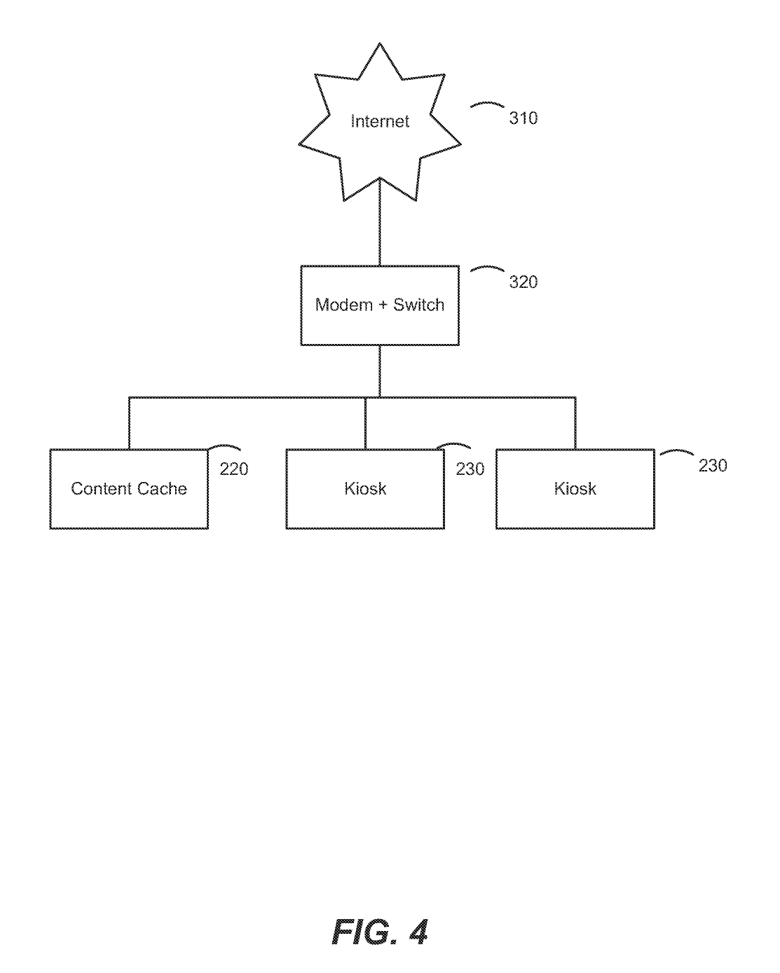

FIG. 4 illustrates one embodiment of a multi-kiosk deployment in a single retail location. Individual locations contain a content cache 220 and at least one kiosk 230. A content cache may serve multiple kiosks 230 that provide the customer interaction with the system. The modem and switch 320 are used to communicatively couple components. The majority of data traffic is between the content cache 220 and kiosk 230. The Internet 310 is used for receiving content updates to the content cache 220, and for exchanging payment verification information with a remote resource (not shown) for purchases made at a kiosk 230.

### Content Provisioning and Updates (Network and Side Loading)

The content cache 220 receives content files from the system server 210, either based on a request from the content update module 222 or based on pre-established distribution policies, and the content cache 220 stores the content files in the content storage 221. In one embodiment, the content storage 221 includes a database, system files, and user files stored on any combination of storage media. The content distribution module 223 also accesses the stored content files from the content storage 221 in order to deliver them to a kiosk 230 in response to requests from the kiosk Media File Processing Module 234.

In one embodiment, content is provisioned prior to shipping the system to the desired location. This may be used so that content is not delivered via a network to reduce the cost and time associated with network delivery. Since content is continually released at irregular intervals, the content provisioned at manufacturing requires updates at least as often as content on kiosks in retail locations. Content updates can be performed via multiple methods.

In order to update the content within the content cache 220, the content module 222 must determine the content that needs to be updated. To do so, the content update module 222 receives a list of files that should be present within the content cache 220. Using the list of files, the content update module 222 determines which files are not currently present locally and creates a list of files that are necessary. Once the list is created, the encrypted content files and metadata are transferred to content storage 221. After download, encrypted content files and metadata are verified to confirm that the transfer was completed without error. Once the verification process is completed, the files are marked as available and can be downloaded to a consumer's portable device 240.

Content files, content keys, and metadata can be transferred via a network over time. As content rights are associated with the DVD window, content may be delivered prior to the DVD window or prior to the Pay-TV window and only made available at the kiosk 230 when that product is within the DVD window for the specific title. Delivering prior to the Pay-TV window enables the content files and keys to be delivered to the portable device 240 via direct connection in compliance with the Pay-TV window restrictions. Content can also be delivered after the Pay-TV window.

Content can alternatively be transferred via physical connection at any time to the store server. Physical connections are not subject to the Pay-TV window restrictions. Physical connections may be flash card (SD card, compact flash), USB (USB flash, USB hard disk drive), eSata, firewire, or hotswap disk drive such as provided by many RAID controllers. Once the disk is electrically connected and the file system recognized by the operating system, the content update module 222 can transfer the content and metadata to local or attached storage.

Content update control can be accomplished either by the end point downloading content from a policy decision (pull), or pushed from the data center. The decision is policy based for autonomy. For example, control afforded at the stores allow multiple data centers to be load balanced to save total costs. There is also the possibility of bit torrent or ad-hoc networks to provide download capability further reducing cost because the outbound network of any particular store may not be fully utilized whereas the outbound network from the data center is likely fully utilized.

Content is synchronized with system storage 211 via the system server 210. The synchronization process can be done via Internet download when content is located via physical connection.

### DRM Key Provisioning, Distribution, and Synchronization

Domain-based DRMs typically use a centralized key server accessed via a network. The key server contains the device mappings for registered consumer devices such that a consumer may register several devices, up to the limit of the DRM. These devices are then provisioned with common encryption key. Through this registration and provisioning process, multiple devices use a single, common key to decrypt content. When content is encrypted for playback on the consumer's device, the key server is contacted in order to retrieve the encryption key. Then the content key is encrypted with the consumer's encryption key. Because the encryption key is retrieved via network, the process is incompatible with the Pay-TV window. This is the typically process used by Internet streaming.

An alternative DRM system uses a device key and an application key. The device key is provisioned into the device, such as during device manufacturing. An additional key (application key) is contained within application software. The application and device use these keys in order perform a mutual authentication process. Using this DRM system, instead of downloading a centralized encryption key, the encryption key is derived using the application and the device keys. The derived key is then be used to encrypt the content key. One such alternate DRM system is CPRM.

There are different types of CPRM for SD cards. One type is SD-Video CPRM. With SD-Video CPRM a unique content key protects every content title. An additional key, the device key, is used to protect the content key. The device key encrypts the content key as stored on the portable device. The content key is protected by the SD card's DRM key (Media Unique Key or MUK). The MUK is derived during the Authentication Key Exchange (AKE). Once the MUK is derived, the content key is encrypted using the MUK along with the usage rules and transferred to the portable device (SD card). An alternate embodiment uses SDSD-Video CPRM.

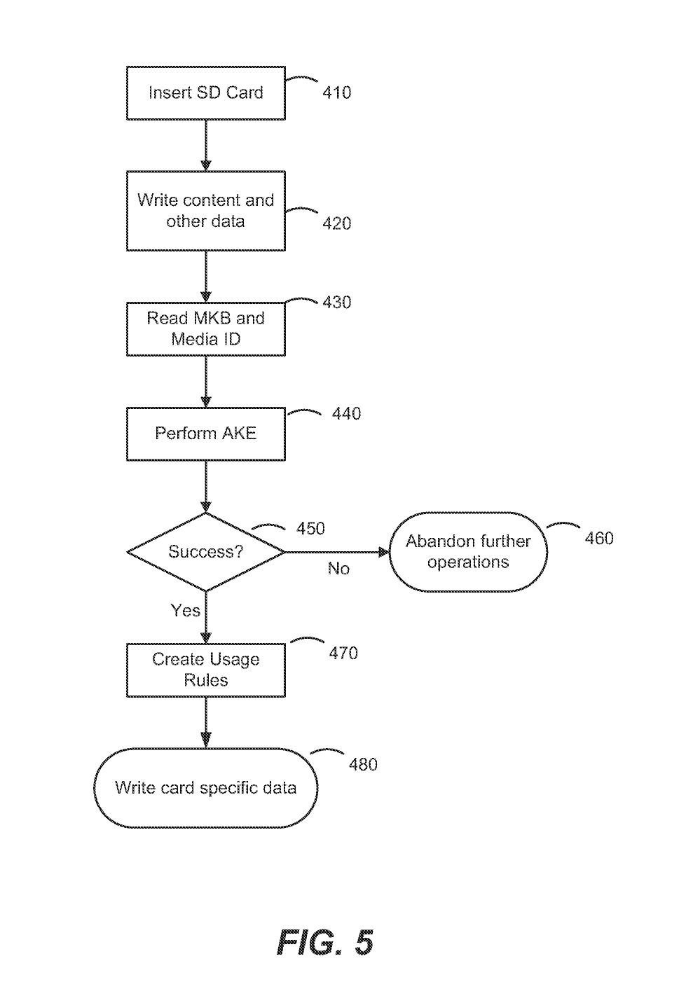

FIG. 5 illustrates the process to transfer content to an SD card using only locally supplied information with SD-Video CPRM. The DRM module 236 initiates the process with step 410 when an SD card (portable device 410) is inserted into the kiosk's external storage interface 237. In some embodiments, the SD card does not need to be removed from a portable device before insertion, if the device can be coupled to the kiosk by other means such as USB, WiFi, or Bluetooth so long as the secure side 242 can be accessed in addition to the user area 240.

The fulfillment module 235 continues with step 420 by transferring to the portable device user area 241 content files, metadata, and other files. During this step, the DRM module 236 transfers key accounting information for the encrypted content key to be written in a later step.

The DRM module 236 continues with step 430 in preparation for AKE. The SD card's media ID and Media Key Block (MKB) are read. When this data is available the AKE can begin.

The DRM module 236 continues with step 440, AKE is performed. This step derives the MUK required for content key encryption, as well as allowing access to the secure area 242. The process then determines if the AKE was successful in step 450.

If unsuccessful, the DRM module 236 terminates the process in step 460. It is important to note that if the process terminates unsuccessfully, the information written to the SD card in previous steps can be removed and the customer is not charged for the content since information necessary to use the content is not transferred until a later step.

If the process is successful, the DRM module 236 continues with step 470, usage rules are created. The usage rules define the content rights associated with the content that is being transferred. Usage rules may be created at other times during the process, and can be written at alternative times.

The process completes in step 480 by writing the remaining card specific data, that data requiring the MUK, and any data necessary to the portable device 240 secure area 242.

Alternative media (USB flash, DVD) can be used so long as the DRM is device-based and not domain-based. CPRM and AACS are alternative DRM examples that can be applied to different physical media such as flash and optical disc.

This process describe a specific sequence of steps (e.g., blocks or logic) in order to transfer data using a device specific DRM to an SD card using the DRM. The process may be completed in different orders, or different flows, but the information transferred is the same.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate or distributed components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily or specially configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example processes described herein, e.g., as described with FIGS. 3, 4 and 5, may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” or the like. These words, however, are merely convenient labels and are to be associated with appropriate physical quantities.

Unless specifically stated otherwise, discussions herein using words such as “processing,” “computing,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 61/474,671, entitled “KIOSK DISTRIBUTION OF LICENSED CONTENT TO PORTABLE DEVICE WITHIN DVD AVAILABILITY WINDOW,” filed Apr. 12, 2011, is incorporated herein by reference, in its entirety.

From the foregoing it will be appreciated that, although specific embodiments have been described herein for purposes of illustration, various modifications and variations, may be made in the arrangement, operation and details of the method and apparatus disclosed herein without deviating from the spirit and scope defined in the following claims. For example, still additional alternative structural and functional designs for a system and a process kiosk distribution of licensed content to portable devices are contemplated through the disclosed principles herein. The methods and systems discussed herein also are applicable to other architectures, differing protocols, communication media (optical, wireless, cable, etc.) and devices (such as wireless handsets, electronic organizers, personal digital assistants, portable email machines, game machines, pagers, navigation devices such as GPS receivers, etc.).

1. A kiosk for transferring content to a portable device, the kiosk comprising:
a fulfillment module configured to prepare encrypted content files and corresponding metadata files then transfer them to the portable device;
a DRM module configured to create the encrypted content key necessary to decrypt the content files and transfer files to the portable device; and
an external storage interface configured to communicatively couple the portable device to the kiosk for transfer of content to the portable device.

2. A content cache for caching content locally to be distributed to kiosks, the content cache comprising:
encrypted content files and corresponding metadata and content keys;
a content update module configured to update the local storage; and
a content distribution module configured to transfer encrypted content files to kiosks in accordance with requirements for continuously maintaining the DVD availability window.

3. The content cache of claim 2 where the encrypted content files and corresponding metadata are loaded during provisioning time.

4. The content cache of claim 2 wherein the content update module is configured to:
determine content to be loaded at the content cache by comparing the content cache contents to system storage contents;
create a list of encrypted content files and metadata to transfer to the content cache;
transfer encrypted content files and metadata to the content cache;
verify the encrypted content files and metadata after the transfer is complete; and
mark the encrypted content files and metadata as available.

5. The content cache of claim 2 where the encrypted content files and corresponding metadata and corresponding content keys are transferred using a USB device.

6. The content cache of claim 2 where the encrypted content files and corresponding metadata and corresponding content keys are transferred using an eSATA device.

7. The content cache of claim 2 where the encrypted content files and corresponding metadata and corresponding content keys are transferred using a firewire device.

8. The content cache of claim 2 where the encrypted content files and corresponding metadata and corresponding content keys are transferred using an SD card.

9. The content cache of claim 2 the encrypted content files and corresponding metadata and corresponding content keys are transferred by hotswapping a hard disk drive.

10. The content cache of claim 2, serving multiple kiosks.

11. A method of securely transferring encrypted content files from a kiosk to a secure digital (SD) card in accordance with requirements for maintaining the DVD availability window, comprising:
reading a media ID and a Media Key block from the SD card;
deriving a Media Unique Key from the media ID and Media Key Block;
encrypting a content key with the Media Unique Key;
creating usage rules for encrypted content files protected by the Media Unique Key; and
writing the usage rules and the encrypted content files to the SD card.

12. The method of claim 11, wherein transferring data to and from the SD card is performed by inserting the SD card into the kiosk.

13. The method of claim 11, wherein transferring the data to and from the SD card is performed while the SD card is inserted into another device and the device is coupled to the kiosk using USB.

14. The method of claim 11, wherein transferring the data to and from the SD card is performed while the SD card is inserted into another device and the device is coupled to the kiosk using WiFi.

15. The method of claim 11, wherein transferring the data to and from the SD card is performed while the SD card is inserted into another device and the device is coupled to the kiosk using Bluetooth.

16. The method of claim 11 where the SDSD-Video CPRM DRM is used.
